(19) United States
(12) Patent Application Publication
(10) Pub. No.: US 2013/0075049 A1
(43) Pub. Date: Mar. 28, 2013

(54) VENETIAN BLIND SLATS HAVING A FUNCTION OF THEIR LEFT AND RIGHT ENDS AUTOMATICALLY ALIGNED

(71) Applicant: Dejun ZHANG, Dongguan City (CN)

(72) Inventor: Dejun ZHANG, Dongguan City (CN)

(21) Appl. No.: 13/241,610

(22) Filed: Sep. 23, 2011

(51) Int. Cl. E06B 9/386

(52) U.S. Cl. 160/236

(57) ABSTRACT

Venetian Blind slats having a function of their left and right ends automatically aligned and able to be assembled on a Venetian blind includes a plurality of slat bodies respectively bored with at least one band insert hole for a connecting band of the blind to be inserted therethrough and connected with the slat body, and each band insert hole is contracted and extended toward a lengthwise edge of the slat body to form a convergent portion. Thus, when the lift cord of the blind is pulled, the slat bodies are to be actuated by a braided ladder to tilt and guided by the convergent portions of the band insert holes to adjust the positions of their left and right ends.

### BACKGROUND OF THE INVENTION

1. Field of the Invention This invention relates to Venetian blind slats having a function of their left and right ends automatically aligned.

2. Description of the Prior Art

A conventional Venetian blind 100, as shown in FIGS. 1, 2 and 3, includes a head rail 10, a slat unit 20, a bottom rail 30, two lift cords 40 and a braided ladder 50 combined together. The slat unit 20 is composed of a plurality of slats 21 arranged parallel to one another, and each slat 21 has positions close to opposite ends respectively bored with an insert hole 22. The braided ladder 50 is composed of two vertical cords 51 respectively provided at two ends of the slats 21, and a plurality of horizontal cords 52 respectively located just under each slat 21 and having two ends connected with the two opposite vertical cords 51 for supporting the slat 21. One of the vertical cords 51 is provided thereon with a connecting band 60 having one end inserted through the insert hole 22 of each slat 21 and then winding around the related lift cord 40 for limiting each slat 21 close each of the vertical cords 51 of the braided ladder 50. Thus, when a user lifts one of the vertical cords 51 of the braided ladder 50, all of the horizontal cords 52 are to be actuated by the vertical cords 51 to make all the slats 21 to turn around with the lengthwise side acting as an axis to let the slats 21 overlapped with one another for blocking external light from getting into a room.

However, the insert holes 22 of the conventional Venetian blind slats 21, referring to FIG. 3, are respectively an elongated oval hole 221 and the longitudinal side of the elongated oval hole 221 is parallel to the lengthwise side of the slat 21; therefore, the slats 21 relative to the braided ladder 50 have a certain degree of freedom to move leftward and rightward. As a result, when the conventional Venetian blind 100 is operated, the slats 21 are easy to shift leftward and rightward, impossible to let the opposite ends aligned in a straight line. Thus, it will not only decrease integral beauty of the conventional Venetian blind 100 but also cause damage to the slats 21 because the opposite ends of the slats 21 are likely to cause friction with the wall of a window.

### SUMMARY OF THE INVENTION

The objective of this invention is to offer Venetian blind slats having a function of their left and right ends automatically aligned for elevating integral aesthetic appearance of a Venetian blind.

The blind slats of this invention can be assembled on a Venetian blind that is provided with a head rail, a bottom rail, at least one lift cord and at least one braided ladder, which are set between both the head rail and the bottom rail, and a plurality of connecting bands axially and equidistantly fixed on the braided ladder. The blind slats are assembled between the head rail and the bottom rail, having a rectangular body that is connected with a related connecting band and has two lengthwise edges defined to be a front edge and a rear edge. Each slat body is bored with at least one band insert hole at a location near the front edge of the slat body for a related connecting band to be inserted therethrough and then connected with the lift cord, and each band insert hole is contracted and extended toward the front edge to form a convergent portion.

By so designing, when the braided ladder is tilted, the slats, with their lengthwise side acting as an axis, are to be actuated by the braided ladder to tilt and simultaneously guided by the convergent portions of the band insert holes to adjust positions of their left and right ends, and when the convergent portions are stuck to the related connecting bands, the left and the right ends of all of the slats can be aligned in a straight line. Thus, the blind slats can be automatically aligned, not only enhancing aesthetic appearance of the whole Venetian blind, but also effectively avoiding damage caused by collision of two ends of the slats with the wall of a window.

### BRIEF DESCRIPTION OF DRAWINGS

This invention will be better understood by referring to the accompanying drawings, wherein:

FIG. 1 is a perspective view of a conventional Venetian blind;

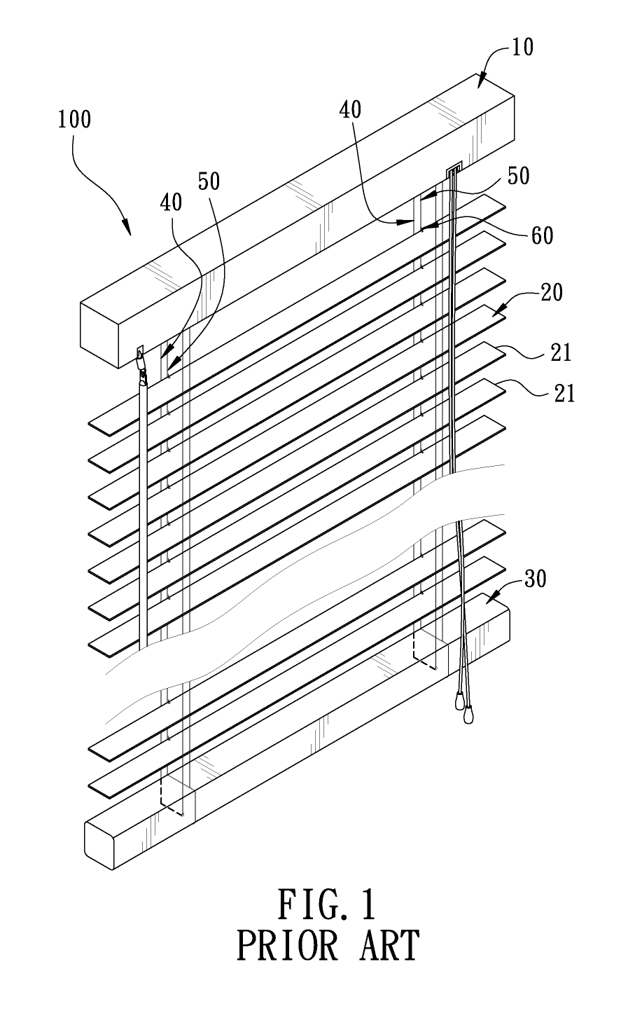

FIG. 2 is a partial magnified cross-sectional view of the conventional Venetian blind;

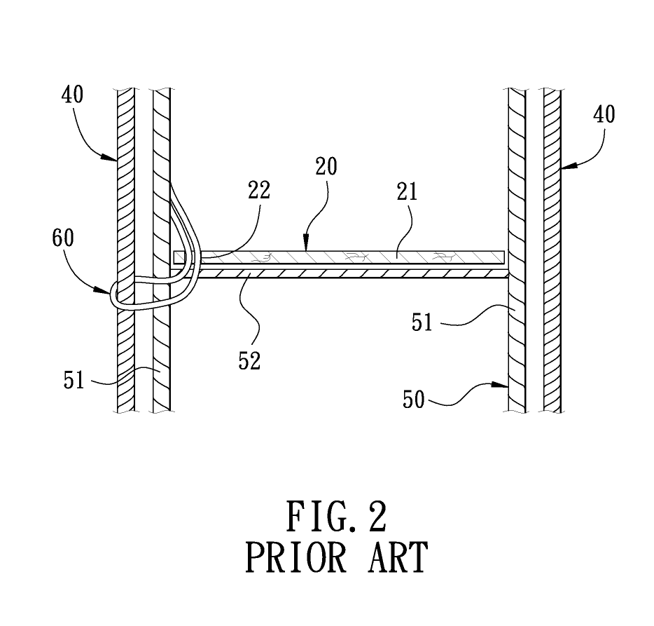

FIG. 3 is a schematic view of the conventional Venetian blind in a using condition;

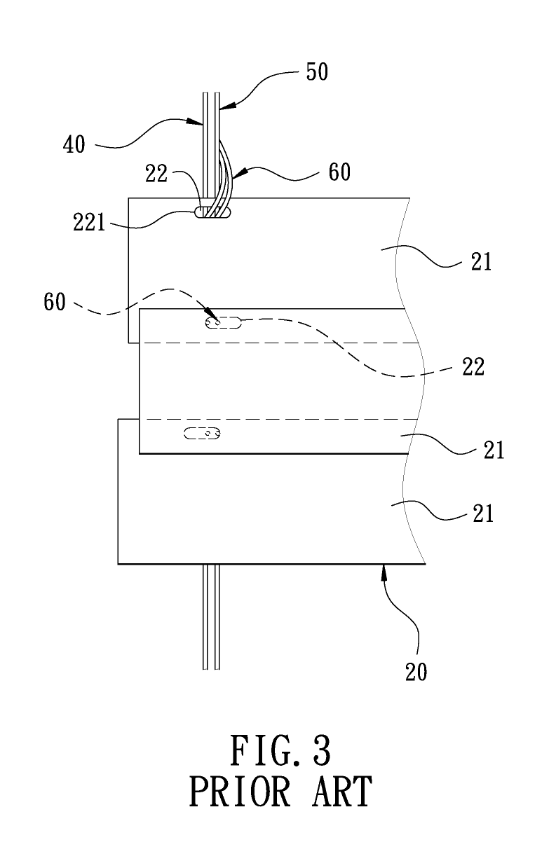

FIG. 4 is a perspective view of a first preferred embodiment of a Venetian blind in the present invention;

FIG. 5 is a perspective view of a slat in the first preferred embodiment in the present invention;

FIG. 6 is a partial magnified cross-sectional view of the first preferred embodiment of the Venetian blind in the present invention;

FIG. 7 is a side cross-sectional view of the first preferred embodiment of the Venetian blind in a using condition in the present invention;

FIG. 8 is a front view of the first preferred embodiment of the Venetian blind in a using condition in the present invention;

FIG. 9 is a perspective view of a second preferred embodiment of a Venetian blind in the present invention;

FIG. 10 is a perspective view of a slat in the second preferred embodiment in the present invention;

FIG. 11 is a perspective view of a third preferred embodiment of a slat body of a Venetian blind in the present invention;

FIG. 12 is a side view of the third preferred embodiment of the Venetian blind in a using condition in the present invention;

FIG. 13 is a front view of the third preferred embodiment of the Venetian blind in a using condition in the present invention;

FIG. 14 is a perspective view of a fourth preferred embodiment of a slat body of a Venetian blind in the present invention; and

FIG. 15 is a perspective view of a fifth preferred embodiment of a slat body of a Venetian blind in the present invention.

### DETAILED DESCRIPTION OF THE PREFERRED EMBODIMENT

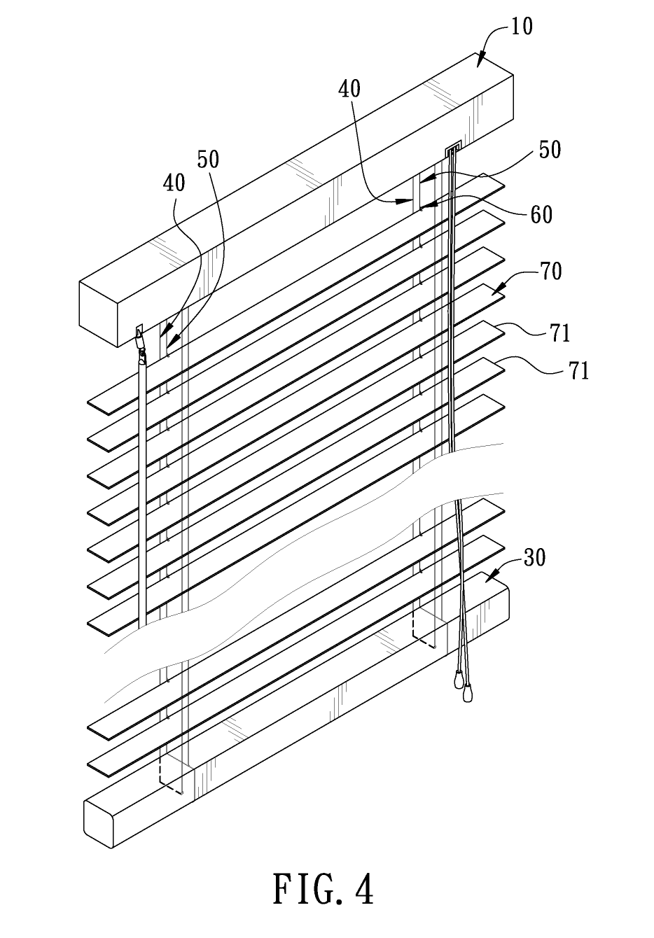

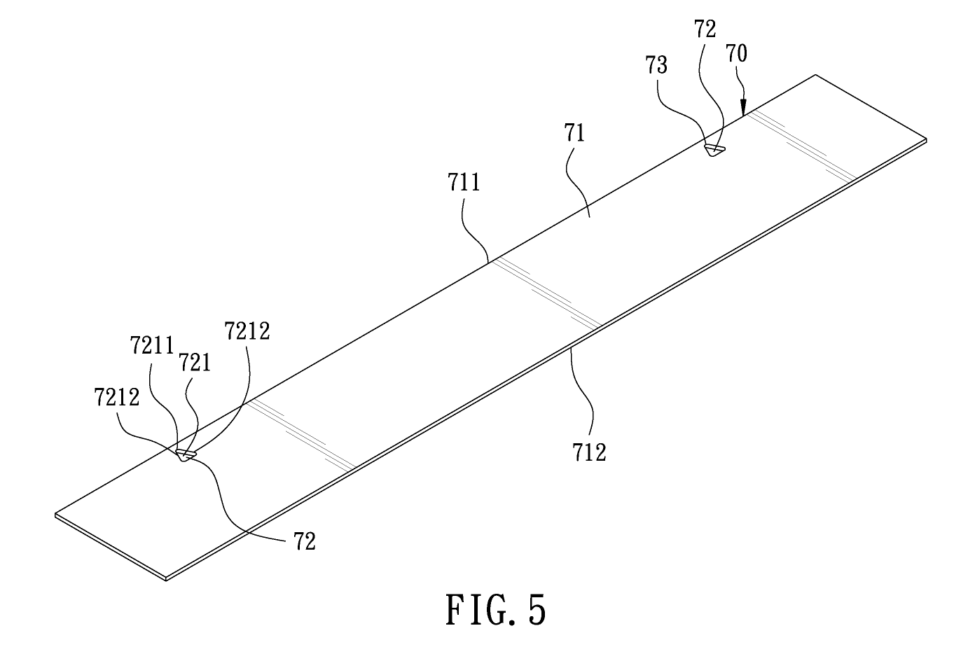

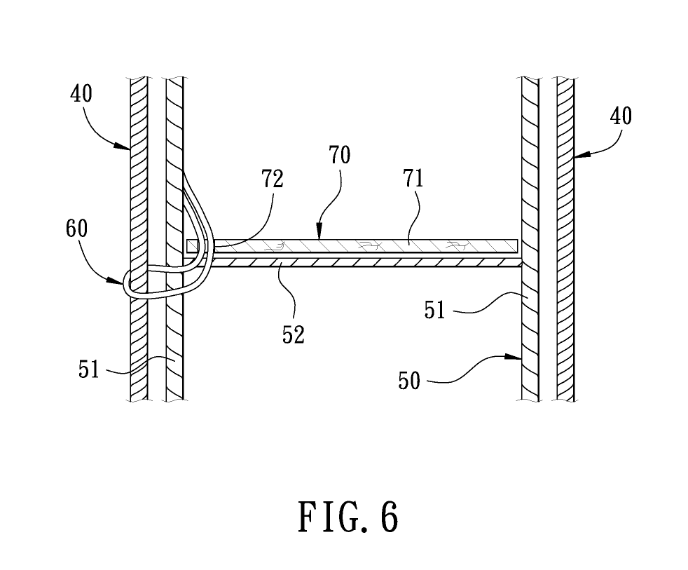

A first preferred embodiment of Venetian blind slats 70 having a function of their left and right ends automatically aligned in the present invention, as shown in FIGS. 4, 5 and 6, can be assembled on a Venetian blind 100. For the convenience of explanation, this invention continues following the number used in the above description of the conventional Venetian blind. A Venetian blind 100 in the present invention includes a head rail 10, a bottom rail 30, at least one lift cord 40, at least one braided ladder 50, a plurality of connecting bands 60 and plural slats 70 as main components combined together.

The lift cord 40 and the braided ladder 50 are set between both the head rail 10 and the bottom rail 30, while the connecting bands 60 are set on the braided ladder 50 spaced apart lengthwise. The slats 70 are assembled between the head rail 10 and the bottom rail 30, respectively having a rectangular body 71 and connected with at least one connecting bands 60, and each slat body 71 has two lengthwise edges respectively defined to be a front edge 711 and a rear edge 712. Further, each slat body 71 is bored with at least one band insert hole 72 for a related connecting band 60 to be inserted therethrough and then connected with the lift cord 40, and each band insert hole 72 is contracted and extended toward the front edge 711 to form a convergent portion 73. In this preferred embodiment, the Venetian blind 100 is provided with two lift cords 40 and one braided ladder 50, and each slat body 71 has two locations close to slat ends respectively bored with a band insert hole 72 at a location adjacent to the front edge 711. The band insert hole 72 is formed into a triangular hole 721 that has one vertex 7211 facing the front edge 711 and two corresponding sides 7212 contracted and stretched toward the front edge 711 to form the convergent portion 73.

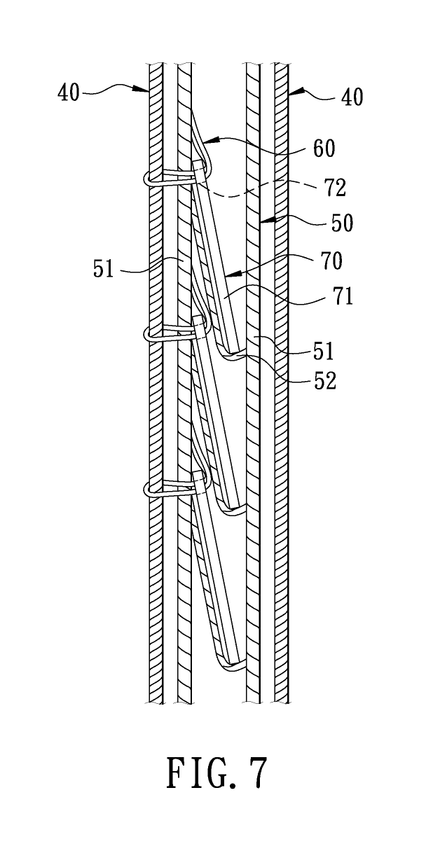

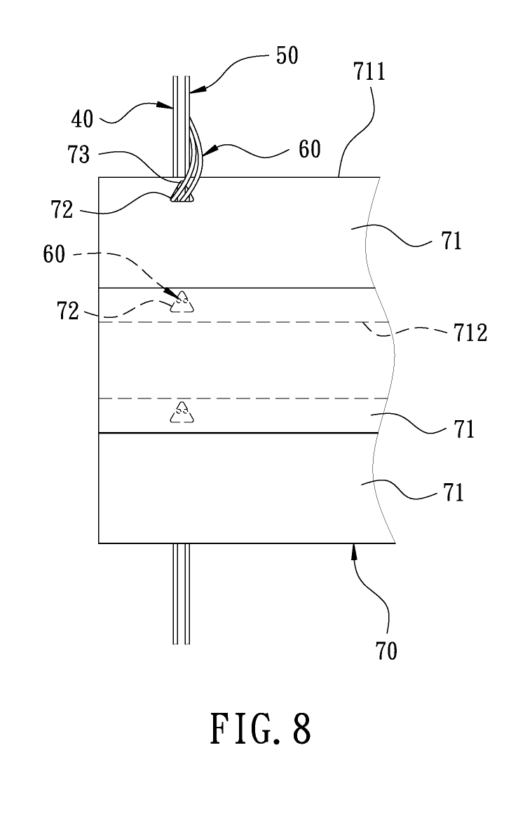

In using, referring to FIGS. 7 and 8, since the band insert holes 72 of the slat bodies 71 are respectively formed with a convergent portion 73, and the slat bodies 71 are constrain at where the braided ladder 50 is located via related connecting bands 60 that are respectively inserted through the band insert holes 72 and then connected with the lift cords 40; therefore, when the lift cord 50 is tilted by a user, the braided ladder 50 will actuate the slat bodies 71 to tilt with the lengthwise side of each slat body 71 serving as an axis. At this time, the slat bodies 71 with their own weight will glide toward the bottom rail, incline simultaneously, and be guided by the convergent portions 73 of the band insert holes 72 and thus to adjust the positions of their left and right ends, and when the convergent portions 73 are moved to stick to the connecting bands 60, the left and the right ends of the slat bodies 71 can be aligned in a straight line. By so designing, all of the blind slats 70 can be automatically aligned, not only increasing aesthetic appearance of the whole Venetian blind, but also avoiding damage caused by collision of two ends of the slat bodies 71 with the wall of a window.

One advantage of this design is that the band insert hole 72 can be provided at a location comparatively closer to the front edge 711 of the slat body 71 so as to increase closing effect between every two slat bodies 71 and increase the vertical distance between slats 71, thus able to reduce the quantity of slats to be used for reducing manufacturing cost.

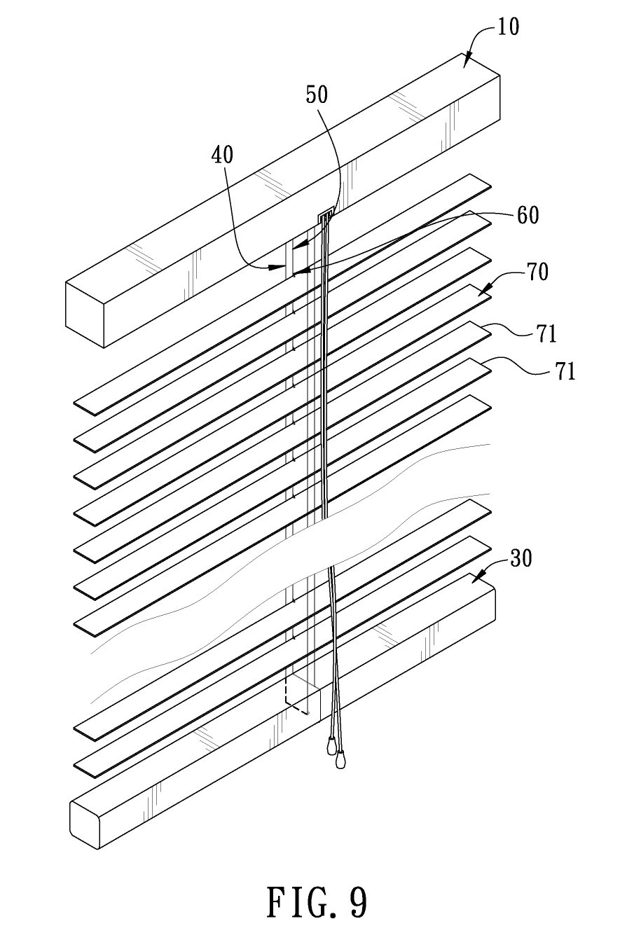

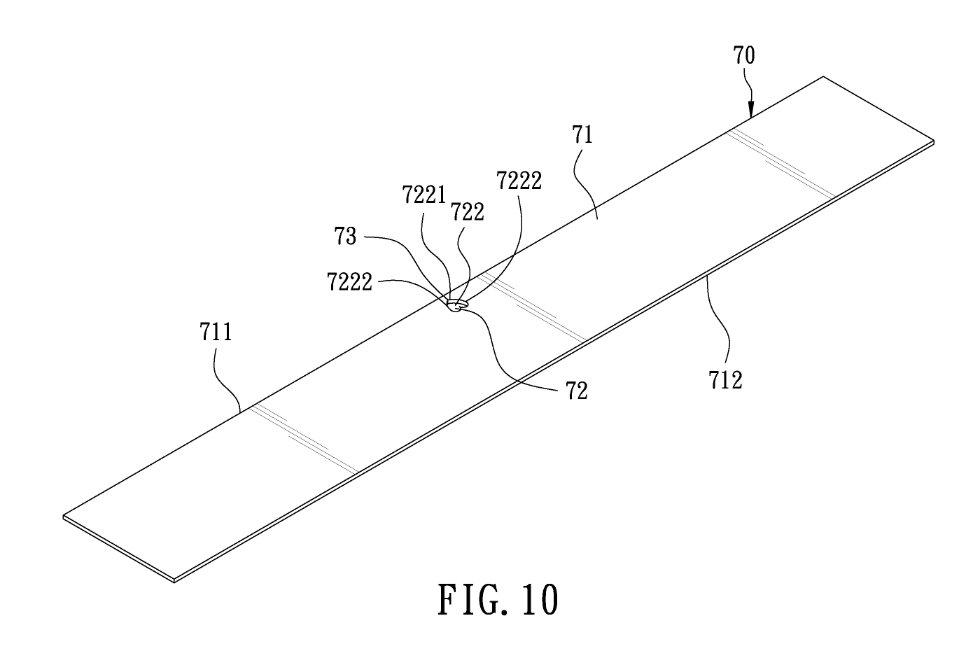

A second preferred embodiment of Venetian blind slats having a function of their left and right ends automatically aligned in the present invention as shown in FIGS. 9 and 10, is to have the Venetian blind 100 provided with only one lift cord 40 and only one vertical ladder cord 50 that is set between both the head rail 10 and the bottom rail 30, and each slat body 71 disposed with only one band insert hole 72 in the middle part lengthwise and at a location near the front edge 711. In this preferred embodiment, the band insert hole 72 of the slat body 71 is a heart-shaped hole 722 whose pointed end 7221 faces the front edge 711, letting two curved sides 7222 of the heart-shaped hole 722 contracted and stretched toward the front edge 711 to form a convergent portion 73. Thus, when the vertical ladder cord 50 is pulled, the slat bodies 71 will be guided by the convergent portions 73 to adjust the positions of their left and right ends, enabling the all blind slats 70 to be automatically aligned in a straight line and thus attaining the same effect as that described in the first preferred embodiment.

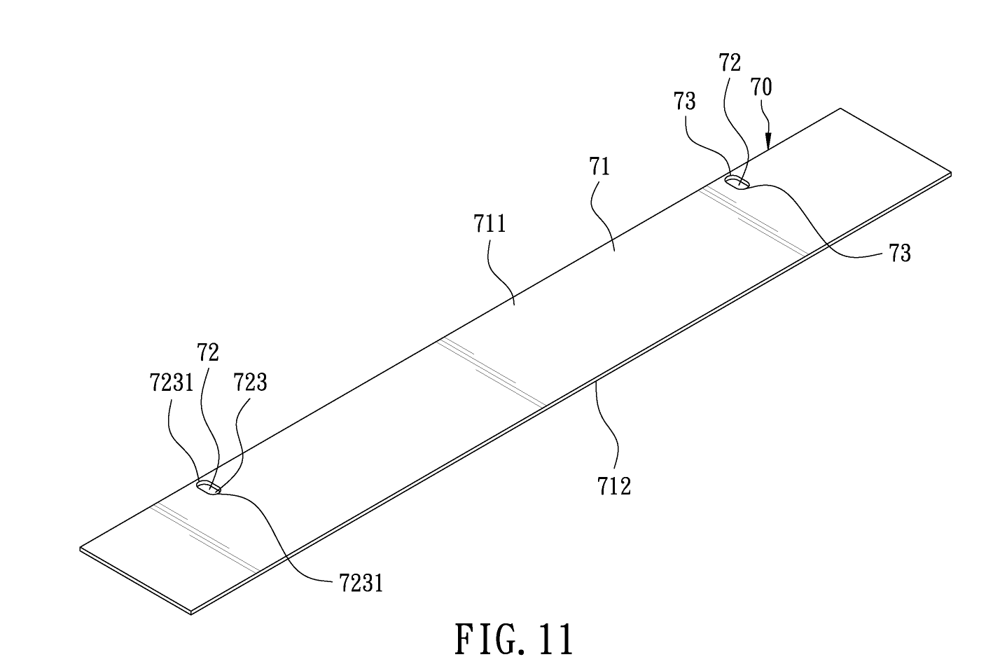

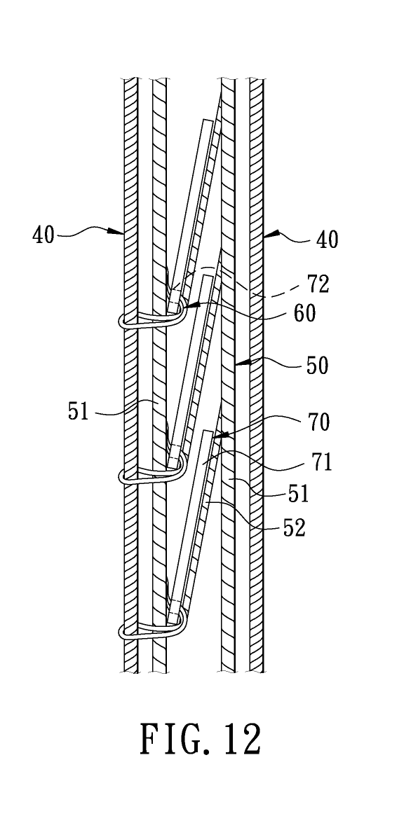

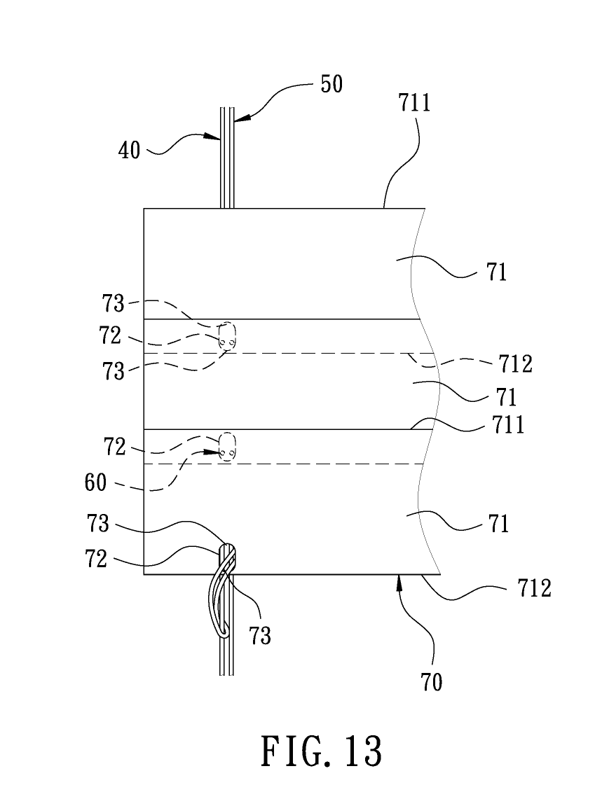

A third preferred embodiment of Venetian blind slats having a function of their left and right ends automatically aligned in the present invention, referring to FIGS. 11, 12 and 13, has almost the same structure as that of the first preferred embodiment, except that the band insert hole 72 has two ends respectively contracted and stretched toward the front edge 711 and the rear edge 712 to form a convergent portion 73. In this preferred embodiment, the band insert hole 72 of the slat body 71 is an elongated oval hole 723 having a longitudinal side being perpendicular to the lengthwise side of the slat body 71 and two circular sides 7231 respectively contracted and stretched toward the front edge 711 and the rear edge 712 to form a convergent portion 73. By so designing, when the vertical ladder cords 50 are pulled up, as shown in FIG. 7, the slat bodies 71 of the Venetian blind 100, as described in the first preferred embodiment, will be guided by the convergent portions 73 close to the front edge 711 to adjust the positions of their left and right ends to enable all the slat bodies 71 to be automatically aligned in a straight line. When the vertical ladder cords 50 are released, the slat bodies 71 will be guided by the convergent portions 73 close to the rear edge 712 to adjust the positions of their left and right ends to let the slat bodies aligned automatically, as shown in FIG. 13. Thus, the blind slats 70 of this invention can be aligned automatically no matter what direction they are tilted.

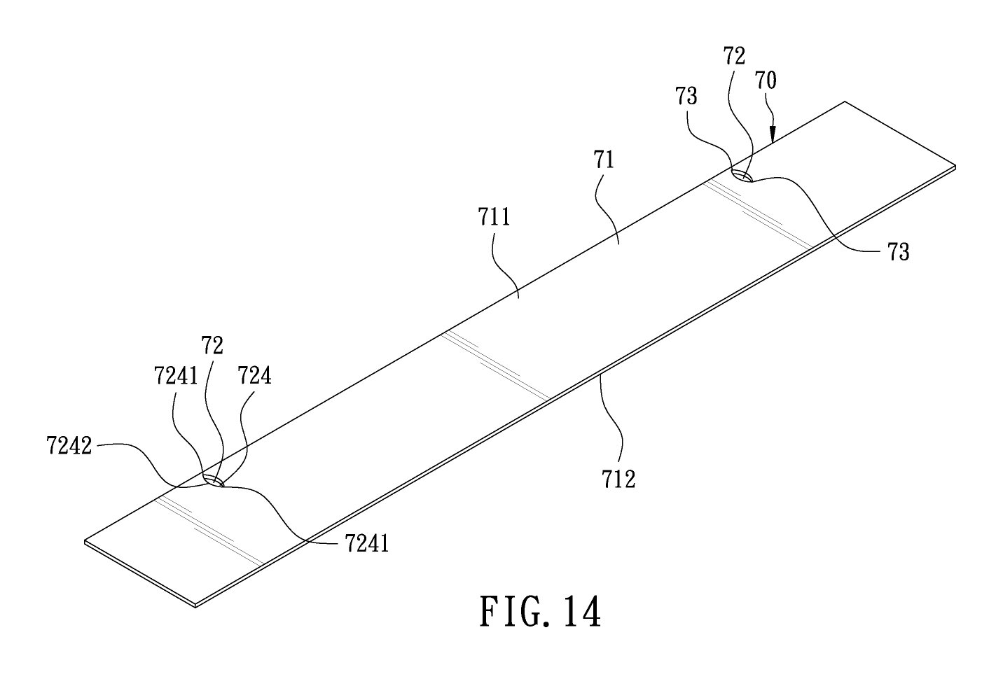

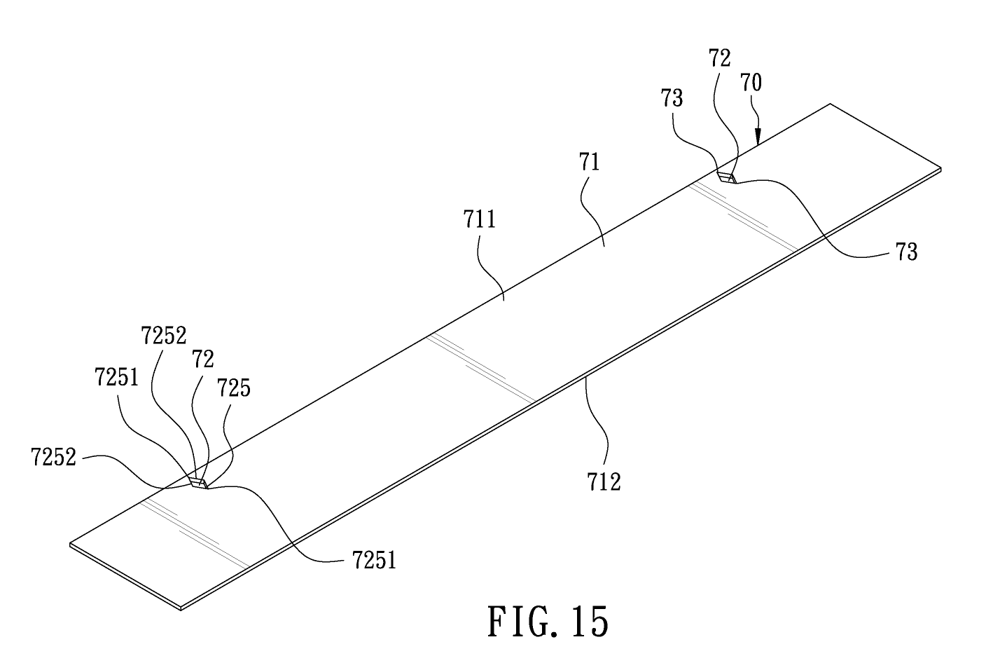

A fourth and a fifth preferred embodiment of Venetian blind slats having a function of their left and right ends automatically aligned in the present invention, as shown in FIGS. 14 and 15, is to have the band insert hole 72 of the slat body 71 converted into an olive-shaped hole 724 and a rhombic hole 725. The olive-shaped hole 724 has two pointed ends 7241 respectively facing the front edge 711 and the rear edge 712, and two curved sides 7242 respectively contracted and extended toward the front edge 711 and the rear edge 712 to form a convergent portion 73 respectively, as shown in FIG. 14. The rhombic hole 725 has two acute angles 7251 respectively facing the front edge 711 and the rear edge 712, and four sides 7252 respectively contracted and extended toward the front edge 711 and the rear edge 712 to form a convergent portion 73, as shown in FIG. 15. Thus, the blind slats 70 can achieve the same effect as described in the third preferred embodiment.

While the preferred embodiments of the invention have been described above, it will be recognized and understood that various modifications including different shapes of the band insert hole 72 as long as it has a convergent portion may be made therein and the appended claims are intended to cover all such modifications that may fall within the spirit and scope of the invention.

What is claimed is:

1. Venetian blind slats having a function of their left and right ends automatically aligned and able to be assembled on a Venetian blind, said blind comprising a head rail and a bottom rail, at least one lift cord and at least one braided ladder, said lift cord and said braided ladder are set between both said head rail and said bottom rail, a plurality of connecting bands axially and equidistantly fixed on said braided ladder; and characterized by,
said blind slats assembled between said head rail and said bottom rail, said slats respectively having a rectangular body connected with related said connecting band, each said slat body having two lengthwise edges defined to be a front edge and a rear edge, said slat body bored with at least one band insert hole at a location near said front edge of said slat body, said connecting band inserted through said band insert hole and connected with said lift cord, each said band insert hole contracted and extended toward said front edge to form a convergent portion; and
said braided ladder actuating all said slat bodies to tilt with a lengthwise side of said slat body acting as an axis when said braided ladder is pulled to move up, said slat bodies guided by said convergent portions of said band insert holes to adjust positions of left and right ends of said slat bodies, said slat bodies having their left and right ends aligned in a straight line when said convergent portions move to stick to related said connecting bands, enabling said all blind slats to be aligned automatically.

2. Venetian blind slats having a function of their left and right ends automatically aligned as claimed in claim 1, wherein said band insert hole is a triangular hole, with one vertex of said triangular hole facing said front edge of said slat body while two corresponding sides of said triangular hole contracted and stretched toward said front edge to form a convergent portion.

3. Venetian blind slats having a function of their left and right ends automatically aligned as claimed in claim 1, wherein said band insert hole is a heart-shaped hole whose pointed end faces said front edge of said slat body, while two curved sides of said heart-shaped hole are contracted and extended toward said front edge to form a convergent portion.

4. Venetian blind slats having a function of their left and right ends automatically aligned as claimed in claim 1, wherein said band insert hole has two ends respectively contracted and stretched toward said front edge and said rear edge and respectively formed with a convergent portion.

5. Venetian blind slats having a function of their left and right ends automatically aligned as claimed in claim 4, wherein said band insert hole is an elongated oval hole having a longitudinal side being perpendicular to a lengthwise side of said slat body and having two circular sides respectively contracted and extended toward said front edge and said rear edge to form a convergent portion.

6. Venetian blind slats having a function of their left and right ends automatically aligned as claimed in claim 4, wherein said band insert hole is an olive-shaped hole having two pointed ends respectively facing said front edge and said rear edge, and two curved sides respectively contracted and extended toward said front edge and said rear edge to form said convergent portion.

7. Venetian blind slats having a function of their left and right ends automatically aligned as claimed in claim 4, wherein said band insert hole is a rhombic hole having two acute angles respectively facing said front edge and said rear edge and four sides respectively contracted and extended toward said front edge and said rear edge to form said convergent portion.

8. Venetian blind slats having a function of their left and right ends automatically aligned as claimed in claim 1, wherein said band insert hole is bored in the middle part lengthwise of said slat body at a location near said front edge.

9. Venetian blind slats having a function of their left and right ends automatically aligned as claimed in claim 1, wherein at least two lift cords and at least a ladder cords are set between both said head rail and said bottom rail, and said slat body has two positions close to both ends respectively bored with a band insert hole at a location near said front edge of said slat.
